(19) United States
(12) Patent Application Publication
(10) Pub. No.: US 2007/0224490 A1
(43) Pub. Date: Sep. 27, 2007

(54) Suspension for the Generation of a Current of Electrons and the Use and the Preparation Thereof

(76) Inventor: Catharina Philippina Janssen, Molenhoek (NL)

Correspondence Address: THE WEBB LAW FIRM, P.C., 700 KOPPERS BUILDING, 436 SEVENTH AVENUE, PITTSBURGH, PA, 15219, US

(21) Appl. No.: 10/576,701

(22) PCT Filed: Oct. 19, 2004
(86) PCT No.: PCT/NL04/00739

§ 371 Date: Mar. 15, 2007

(30) Foreign Application Priority Data
Oct. 20, 2003 (NL) 1024573

(51) Int. Cl. H01M 8/00

(52) U.S. Cl. 429/46; 429/122; 435/14; 530/350; 530/359

(57) ABSTRACT

The present invention relates to a suspension that can be used to generate a current of electrons, which suspension comprises a polypeptide, wherein the polypeptide is entrapped in a hollow particle. It also relates to the use of the suspension described above for the production of a battery.

### FIELD OF THE INVENTION

The present invention relates to a suspension that can be used to generate a current of electrons, the use of the suspension for the production of a battery or more specifically of a nano-battery for the use in combination with a microchip. The present invention furthermore relates to a battery using the suspension, a fuel cell comprising: an anode compartment including an anode; a cathode compartment including a cathode; and disposed within said anode compartment, within said cathode compartment, or between said anode compartment and said cathode compartment, the suspension, a device for detection of a solute using the suspension, more specifically a device for the detection of glucose, a method of producing electrical power comprising the use of the suspension, and a method for preparing the suspension.

### BACKGROUND OF THE INVENTION

Known systems for generating energy use enzymes that are embedded in a biocompatible membrane, which enzymes can generate electrons which can be utilized for the generation of electrical energy (WO 03050896). The membrane required for such an approach must be biocompatible to ensure activity of the membrane proteins. The membrane can not be permeable for many solutes because the enzymes are not active in this situation. The above requirements limits the choice of membranes and vesicles and only membrane proteins can be used in this system.

### SUMMARY OF THE INVENTION

The present invention relates to a suspension that can be used to generate a current of electrons, which suspension comprises a polypeptide, characterized in that the polypeptide is entrapped in a hollow particle. Because the polypeptide is entrapped and not embedded in the shell of the hollow particle, the hollow particle could have a shell that has unique properties, such as selective permeability, robustness and conductivity. The polypeptide can be any polypeptide that is active in an aqueous solution. The suspension preferably contains more hollow particles, in which preferably more than one polypeptide is entrapped.

Preferably the density of the hollow particles in the suspension is such that the majority of the hollow particles is in close contact to each other for a more efficient generation of current of electrons. The hollow particle holds the polypeptide in a certain distribution within the suspension so the activity of the polypeptide is also well distributed and will stay well distributed. Preferably the hollow particle is not permeable to the polypeptide. In a preferred aspect, the invention relates to a hollow particle that is a vesicle. A vesicle is a particular hollow particle that is composed of amphiphilic molecules that form the outer shell. Vesicles that entrap a polypeptide can be prepared by adding the molecules to the polypeptide. In another aspect of the present invention the hollow particle is a polymersome. A polymersome is a vesicle that is constructed from polymeric amphiphilic building blocks and can have unique properties such as rigidity and the ability to conduct electrons. In another aspect of the present invention the shell of the hollow particle is conductive. Because of the conductivity the electrons generated within the hollow sphere are transported via the conducting outer shells of the hollow particles and can be transported to the anode. Preferably there is no accumulation of electrons inside the hollow particles and transport of electrons is proceeding via the outer shell. In another aspect of the present invention the hollow particle is composed of conductive polymer. Specific types of polymers can easily conduct electrons and are readily synthesized. In another aspect of the present invention the hollow particle is composed of a block-copolymer. This polymer readily forms vesicles and forms a conductive outer shell. In another aspect of the present invention the hollow particle is composed of a rigid helical polyisocyanide head group and a flexible polystyrene tail, preferably polystyrene-b-poly(L-isocyanoalanine(2-thiophen-3-yl-ethyl)amide) (PS—PIAT). PS—PIAT is able to form very stable and well-defined polymersomes in water (FIG. 3). The vesicles, which are formed upon dispersal of the macromolecules described above in an aqueous solution, are very robust, but still permeable for a substrate like glucose. This amphiphilic macromolecule is a rod-coil type of block copolymer. The membrane thickness of 30±10 nm was determined by scanning electron micrograph (SEM). In another aspect of the present invention the thiophene side groups present in the side chain of PS—PIAT are polymerized, thereby providing the vesicles with a more conducting polymer outer and inner shell. This can be performed electrochemically or by chemical oxidation. This polymerization results in cross-linking of the polymersome membrane. Studies have shown that the electron conducting properties of the PS—PIAT polymersomes improve after cross-linking. It has already been demonstrated that a variety of enzymes can be successfully incorporated within the aqueous inner compartment of the vesicles composed of PS—PIAT, and that after polymerization of the vesicle shells the enzymes can no longer leak out and are protected from protease degradation. Catalysis experiments with other enzymes have confirmed that the enzymatic activity of the included species is retained due to protection of the polypeptide from proteases by the vesicle membrane.

In yet another aspect of the present invention the polypeptide is capable of participating in a chemical reaction or is capable in participating in the formation of a molecular structure that facilitate such reaction. The chemical reaction can result in release of electrons that can be transported through the shell of the hollow particle, preferably through the conductive outer shell of vesicles. Such a polypeptide could potentially be a genetically modified polypeptide that is very stable for a long time. The polypeptide could be linked to the inner side of the vesicle by for example a lipophylic tail attached to the enzyme. The polypeptide preferably is an enzyme and in a preferred embodiment of the present invention the hollow particle is permeable to a substrate of the enzyme. There are many enzymes known that catalyze a chemical reaction that release electron(s). Those enzymes can be used in a suspension according to the present invention. The chemical reaction preferably is a redox reaction. With redox reaction electrons are released and can diffuse to the shell of the hollow particle and can be transported through the shells in a specific direction. More preferred is that the chemical reaction is an oxidation. Many enzymes in nature catalyze an oxidation reaction and the substrates for those enzymes are molecules that are easily available and relatively cheap. In a preferred embodiment the polypeptide is a glucose oxidase. In this embodiment the chemical reaction is the conversion of β-D-glucose into D-glucono-1,5-lactone. During this reaction two electrons are released, see below.

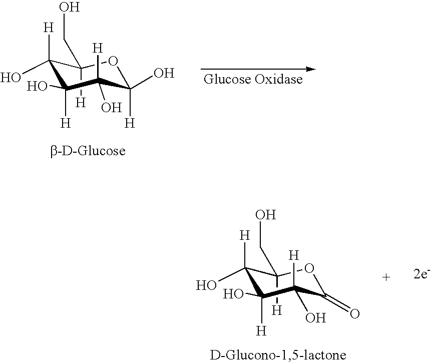

The electrons that are liberated can be easily accepted by the conductive shell of the hollow particles, which also serve as organic electrodes. Glucose oxidase is relatively stable and a well known enzyme. In another preferred aspect, the invention relates to a suspension wherein the hollow particle is embedded in a gel-like structure. In a gel-like structure the hollow particles diffuse slowly and the substrate diffuses slowly. Preferably the hollow particle is embedded in a glucose solution. Glucose is a good substrate for glucose oxidase and not expensive. In this respect of the invention glucose is the fuel from which electrons will be produced and is readily available and a relatively cheap. The combination glucose/glucose oxidase is a good and often used combination of enzyme/substrate. Glucose furthermore is stable and is obtainable in a very pure form. The electrons can find their path via the conductive outer shell(s) of the hollow particles, on the condition that the majority of the hollow particles contact each other (FIG. 2). If this electronic communication is less efficient, a preferred embodiment of the invention comprises a matrix to contact at least one hollow particle for carrying out the electron transport, for example a conducting polymer (e.g. a polythiophene) that contacts the vesicles (FIG. 2). In another aspect of the present invention the matrix can cross-link at least one hollow particle to another hollow particle. The matrix can for example be partially embedded in the shell of some of the hollow particles. The suspension contains in a preferred embodiment known electron carriers such as ferrocene derivatives and viologen derivatives in order to facilitate electron transport.

The present invention also relates to the use of the suspension described above for the production of a battery. Preferably the suspension described above is used for the production of a nano-battery for the use in combination with a microchip.

The present invention furthermore relates to a battery using the suspension described above. Such a battery can use relatively cheap fuel, like glucose, and can deliver a constant current. Since it can be chosen that the components of such a battery are not toxic it is saver for use in for example a pace maker in humans. No known toxic compounds (except for the viologen derivatives) are included so there is no toxicity risk involved. In addition such a battery is not harmful for the environment.

The present invention furthermore relates to a fuel cell comprising: an anode compartment including an anode; a cathode compartment including a cathode; and disposed within said anode compartment, within said cathode compartment, or between said anode compartment and said cathode compartment, the suspension described above. The electrons can find their path in the direction of the anode via the conductive outer shell of the hollow particle(s). See FIG. 1.

The present invention also relates to a device for detection of a solute using the suspension described above. The suspension preferably comprises an enzyme that can chemically convert the solute. Preferably with these conversion electrons are released. A specific embodiment of the present invention in this respect relates to a glucose sensor using the suspension described above. Preferably the polypeptide in this embodiment is a glucose oxidase. When glucose is sensed the glucose oxidase uses the glucose as a substrate and electrons are released. The electrons move via the outer shells of the hollow particles to an anode and a current of electrons can be detected. In another aspect the present invention relates to a method of producing electrical power comprising the use of the suspension described above. Because of the natural source of energy this kind of electrical power is not harmful for the environment. The electrical power can for example be used for cars. The present invention furthermore relates to the process for preparing the suspension described above, comprising the steps of: (a) malting an aqueous solution of bis(2,2′-bipyridine)ruthenium(II)bis(pyrazolyl); (b) injecting a solution containing polystyrene-b-poly(L-isocyanoalanine(2-thiophen-3-yl-ethyl)amide) in THF into the solution made in step (a). See example 1 for more details. Preferably the process furthermore comprises: (c) placing the dispersion made in step (b) at 60° C.; (d) cooling the dispersion to room temperature, and (e) filter dispersion of step (d) using a filter with a cutoff of 100 kDa. See example 1 for more details.

### BRIEF DESCRIPTION OF THE DRAWINGS

FIG. 1 shows a schematic picture of a designed battery. The plates are representations of electrodes of which the upper is the cathode and the plate below is the anode. The hollow particles are represented as circles of which one is enlarged at the right of the picture. The large arrows indicate the flow of respectively glucose (left arrow) and gluconolactone (right arrow), which is respectively the substrate and the product of the enzyme glucose oxidase which is indicated as circles entrapped in the hollow particle. The shell of the particle is shown as a shell composed of amphiphilic molecules. The small arrow indicates the flow of electrons.

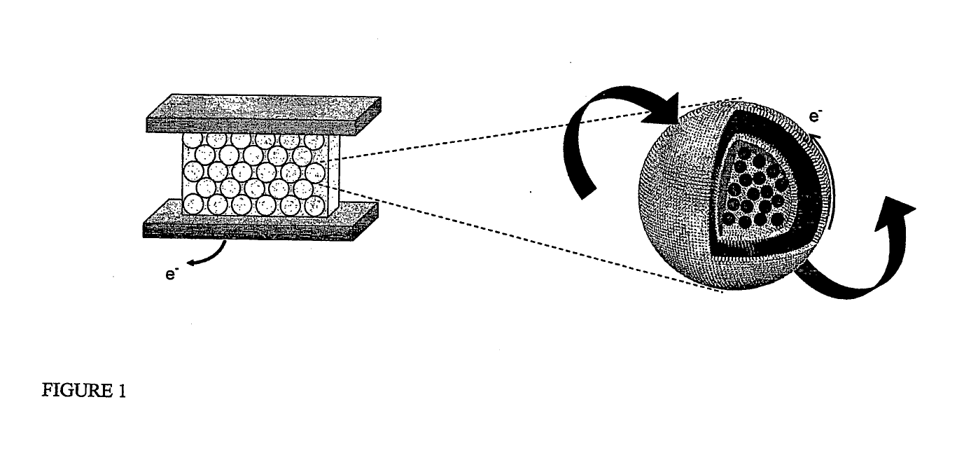

FIG. 2 is a schematic representation of two different ways of electron transport pathways. (a) Hollow particles contact each other and create an electronic pathway via their conductive outer shells. (b) Vesicles are entrapped in a matrix of a conductive polymer which transports the electrons.

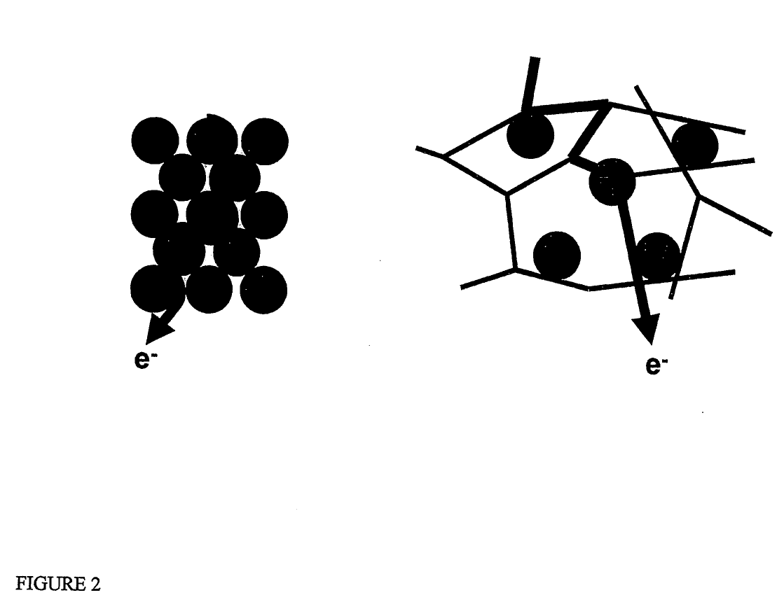

FIG. 3. Left: structure formula of PS—PIAT, middle: scanning electron micrograph of PS—PIAT polymersomes formed in an aqueous solution, right: schematic representation of a polymersome, indicating the membrane thickness of 30 nm.

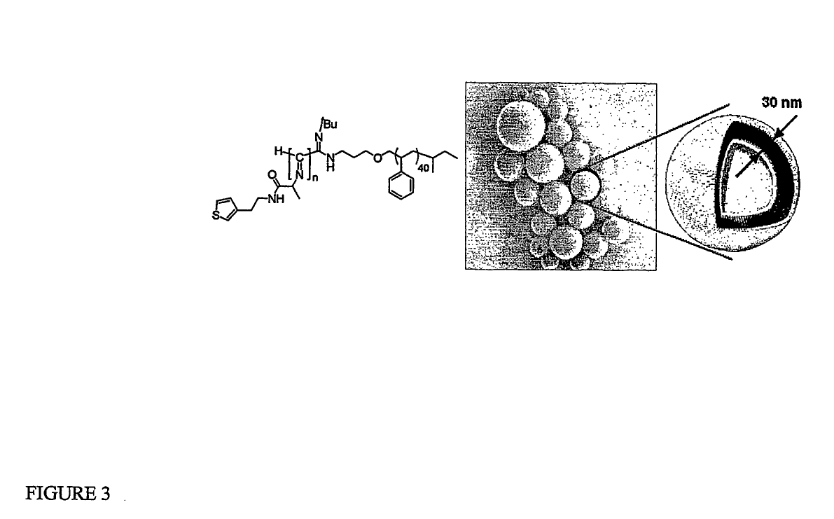

FIG. 4. TEM micrograph of the aggregates formed by the compartmentalization of GOx within PS—PIAT polymersomes.

FIG. 5. Chemical structure of the block-copolymer of polystyrene and thiophene-functionalized polyisocyanopeptide and the micrometer-sized vesicles are formed upon dispersal of the macromolecule in water.

### DETAILED DESCRIPTION OF THE INVENTION

### EXAMPLE 1

1. Entrapment of the Glucose Oxidase.

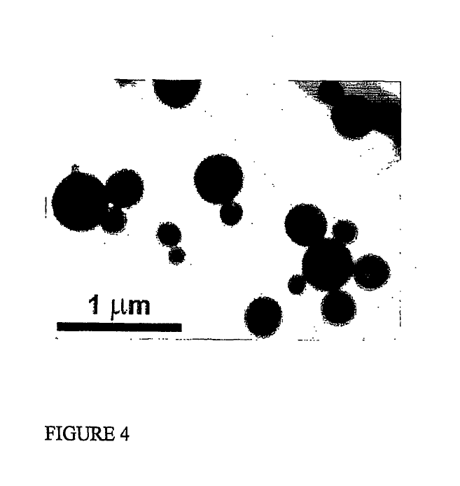

Encapsulation of the GOx enzymes was carried out by preparing a solution of 48 mg.l⁻¹ GOx dissolved in phosphate buffer (20 mM, pH 7.0). Into this solution a 1.0 mg.ml⁻¹ solution of PS—PIAT in THF was injected resulting in a final buffer to THF ratio of 6:1 (v/v). The free enzyme was removed by size exclusion chromatography using Sephadex G-50 and an aqueous phosphate buffer (pH 7.5) as eluent. TEM micrographs of the resulting aggregates are shown in FIG. 4.

2. Cross-Linking of the Polymersome Membrane

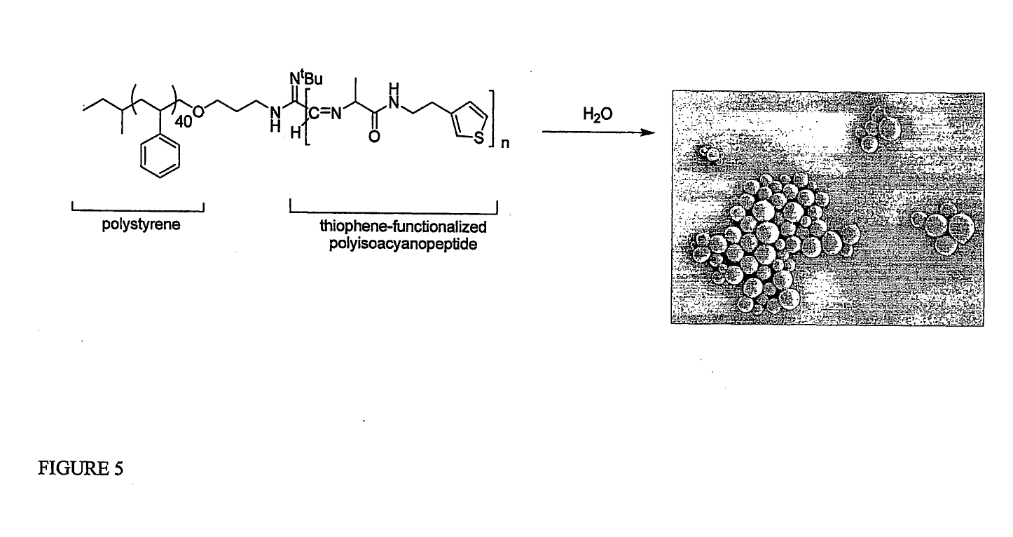

Cross-linking of the PS—PIAT polymersome membrane was done by making an aqueous solution of 0.20 ml of 30 mg.l⁻¹ CAL B and 1.0 ml of 1.3 μM BRP in which 0.10 ml of a solution containing 0.50 g.l⁻¹ PS—PIAT in THF was injected, resulting in a final water/THF ratio of 12:1 (v/v). A concentration of BRP was chosen that was comparable to the amount of thiophene groups present (2×10⁻⁷ M). Subsequently, the dispersion was placed in a water bath of 60° C. for the desired period of time. After cooling to room temperature 0.50 ml of the dispersion was transferred to an eppendorf having a filter unit with a cutoff of 100 kDa The dispersion was centrifuged to dryness after which 0.50 ml of pure water was added and the dispersion was centrifuged again to dryness. After repeating this step a second time, 0.50 ml of water was added to redisperse the cross-linked aggregates. See also FIG. 5.

3. Reaction Chamber

A confined reaction chamber of about 1-2 cm³ is filled with a water-based dispersion of the Glucose Oxidase-containing vesicles. The ‘fuel’ glucose can be dissolved in this dispersion up to relatively high concentrations. On the top and the bottom of the reaction chamber, two electrodes are attached (constructed of e.g. Indium Tin Oxide (ITO)). Upon the application of a voltage, electrons generated in the battery can be transported to an external capacitor from which a constant current can be liberated to the device that has to be supported.

4. Prediction of Performance

For the desired nano-battery an average electric current of approximately 200 mA is required, which means that 1.25×10¹⁸ electrons are needed per second. The following calculations have been made assuming a maximum performance of a cell of 1 cm³. The required electric current corresponds to 6.25×10¹⁷ enzymatic reactions per second. Taking into account the reported turnover number of Glucose Oxidase (22,800/s), this means that 2.7×10¹³ enzymes are needed (corresponding to about 4 micrograms). Simultaneously, 2.7×10¹³ molecules of glucose are convelted per second (corresponding to about 8 nanograms). Assuming that about 5000 enzymes of Glucose Oxidase are included in one vesicle (an assumption based on other vesicle-enzyme systems), 5.4×10⁹ vesicles are needed, which have an average diameter of 1 micrometer. If a compartment of 1 cm³ is filled with a solution or gel containing 20 volume % of vesicles, this means that 2×10¹³ vesicles are present, a 3700-fold excess of the required amount. This means that the maximum performance of such a system results in the generation of an electric current of 740 A. At the average operating current of 200 mA, and assuming an amount of glucose ‘fuel’ of 250 mg per cm³, the battery can operate continuously for a period of about 8700 hours (1 year). At this point the performance-limiting factor is the amount of glucose present and the build up of side products glucoselactone and protons. The system will, however, be subject to other factors that can affect its performance. One can think about enzyme degradation, in particular when the system is operating for a longer time. In addition, an important factor determining performance will be the efficiency of electron transport from the battery to the anode. Several of the parameters of the battery can however be easily varied (e.g. the amounts of vesicles or glucose, the nature of the matrix).

1. A suspension that can be used to generate a current of electrons, which suspension comprises a polypeptide, wherein the polypeptide is entrapped in a hollow particle.

2. The suspension according to claim 1, comprising more than one hollow particle.

3. The suspension according to claim 2, wherein the density of the hollow particles in the suspension is such that the majority of the hollow particles is in close contact to each other.

4. The suspension according to any of claims 1-3, wherein the hollow particle is a vesicle.

5. The suspension according to claim 4, wherein the vesicle is a polymersome.

6. The suspension according to claim 5, wherein the shell of the hollow particle is conductive.

7. The suspension according to claim 6, wherein the hollow particle comprises conductive polymer.

8. The suspension according to claim 7, wherein the hollow particle comprises a block-copolymer.

9. The suspension according to claim 8, wherein the block-copolymer comprises a hydrophobic polystyrene block and a hydrophilic polyisocyanopeptide.

10. The suspension according to claim 8, wherein the block-copolymer comprises polystyrene-b-poly(L-iscyanoalanine(2-thiophen-3-yl-ethyl)amide) (PS—PIAT).

11. The suspension according to claim 8, wherein side groups present on the block-copolymer are polymerized.

12. The suspension according to claim 10, wherein the thiophene side groups present in the side chain of polystyrene-b-poly(L-iscyanoalanine(2-thiophen-3-yl-ethyl)amide) are polymerized.

13. The suspension according to claim 1, wherein the polypeptide is linked to the inner side of the hollow particle.

14. The suspension according to claim 1, wherein the polypeptide is capable of participating in a chemical reaction or is capable in participating in the formation of a molecular structure that facilitates such reaction.

15. The suspension according to claim 14, wherein the chemical reaction is a redox reaction.

16. The suspension according to claim 14, wherein the chemical reaction is an oxidation.

17. The suspension according to claim 1, wherein the polypeptide is an enzyme.

18. The suspension according to claim 17, wherein the hollow particle is permeable to a substrate of the enzyme.

19. The suspension according to claim 16, wherein the enzyme is glucose oxidase.

20. The suspension according to claim 19, wherein the hollow particle is permeable to a substrate of glucose oxidase.

21. The suspension according to claim 20, wherein the hollow particle is permeable to glucose.

22. The suspension according to claim 1, wherein the hollow particle is embedded in a gel-like structure.

23. The suspension according to claim 1, wherein the hollow particle is embedded in a glucose solution.

24. The suspension according to claim 1, comprising a matrix, for example a linear conductive polymer, to contact the hollow particle.

25. The suspension according to claim 2, comprising a matrix, for example a linear conductive polymer, to cross-link at least one hollow particle to another hollow particle.

26. The suspension according to claim 1, comprising electron carriers such as ferrocene derivatives and viologen derivatives.

27. A battery having an electrolyte suspension comprising a polypeptide, wherein the polypeptide is entrapped in a hollow particle.

28. A nano-battery for the use in combination with a microchip having an electrolyte suspension comprising a polypeptide, wherein the polypeptide is entrapped in a hollow particle.

29. (canceled)

30. A fuel cell, comprising: an anode compartment including an anode; a cathode compartment including a cathode; and disposed within said anode compartment, within said cathode compartment, or between said anode compartment and said cathode compartment, the suspension comprising a polypeptide, wherein the polypeptide is entrapped in a hollow particle.

31. A device for detection of a solute comprising a suspension comprising a polypeptide, wherein the polypeptide is entrapped in a hollow particle.

32. The device according to claim 31, wherein the solute is glucose.

33. A method of producing electrical power, comprising generating a current in a suspension comprising a polypeptide, wherein the polypeptide is entrapped in a hollow particle.

34. A method for preparing a polypeptide suspension, wherein the polypeptide is entrapped in a hollow particle, comprising the steps of:
(a) making an aqueous solution of bis(2,2′-bipyridine)ruthenium(II)bis(pyrazolyl);
(b) injecting a solution containing polystyrene-b-poly(L-iscyanoalanine(2-thiophen-3-yl-ethyl)amide) in THF into the solution made in step (a).

35. The method according to claim 34, further comprising:
(c) placing the dispersion made in step (b) at 60° C.;
(d) cooling the dispersion to room temperature; and
(e) filter the dispersion of step (d) using a filter with a cutoff of 100 kDa.
